(19) United States
(12) Patent Application Publication
(10) Pub. No.: US 2006/0285432 A1
(43) Pub. Date: Dec. 21, 2006

(54) Device for mixing at least two media

(76) Inventors: Thomas Brinz, Bissingen A.D. Teck (DE); Jorg Jockel, Gerlingen (DE); Andreas Muller, Gerlingen (DE)

Correspondence Address: KENYON & KENYON LLP, ONE BROADWAY, NEW YORK, NY, 10004, US

(21) Appl. No.: 11/253,095

(22) Filed: Oct. 17, 2005

(30) Foreign Application Priority Data
Oct. 19, 2004 (DE) 102004050790.2

(51) Int. Cl. B01F 7/00

(52) U.S. Cl. 366/315

(57) ABSTRACT

A device for mixing at least two media, in particular highly viscous media, having at least one mixing chamber, its volume in a mixer housing being variable by a movable plunger, and having at least one mixing tool. With the aid of an actuator, the mixing tool is insertable into the mixing chamber for mixing the media and is retractable from the mixing chamber following the mixing.

### FIELD OF THE INVENTION

The present invention relates to a device for mixing at least two media, particularly highly viscous media.

### BACKGROUND INFORMATION

A multitude of devices for mixing substances such as fluids, for example, which are used to mix components that differ in at least one property, are known to be in practical use. Depending on the given states of aggregation, the flow properties, the mixture ratios and the desired degree of homogenization of the media to be mixed, suitable devices are used for this purpose, having one or more chambers, in which the media to be mixed are located, and having mixing organs situated therein.

For highly viscous media such as pastes, mixers are also known, in which a crosswise mixing of the media is achieved by artificially generated turbulences so as to achieve a sufficient intermixture. For highly viscous media, so-called spiral, anchor, coaxial and multi-shaft agitators are used as mixing organs. Furthermore, planet mixers, trough mixers, plunger kneaders and worm machines are also known for mixing highly viscous media. In all these mixing devices, the blending of the media to be mixed occurs by a rotation of a mixing tool.

Furthermore, a device for mixing at least two substances, particularly fluids, which comprises a mixing chamber in which a mixing tool is located, is described in German Patent Application No. DE 101 52 115. In this instance, the mixing tool is operable in a plunger-like and linear moving manner and has a connector for an actuator, the mixing of the substances thereby occurring in particular by repeated, axially oriented linear movements of the plunger-like mixing tool in the mixing chamber.

In order to achieve a satisfactory mixture of highly viscous or plastic-viscous media, the mixing organs in the known mixing devices require a comparatively large volume in the mixing chamber, and the mixing occurs at a high dead volume. Furthermore, comparatively large residues remain on the mixing organs such that the use of expensive base materials produces valuable waste, or that the use of the relevant mixing device proves to be uneconomical.

It is therefore an objective of the present invention to provide a device for mixing at least two media of the type mentioned above, in which for any type of media to be mixed an optimum mixing performance is ensured and at the same time a production of residue is reduced to a minimum.

### SUMMARY OF THE INVENTION

An advantage of an optimum intermixture and a minimization of waste is obtained if a device for mixing at least two media, in particular highly viscous media, having at least one mixing chamber, the volume of which in a mixer housing is variable with the aid of a movable plunger, and having a mixing tool, is designed in such a way that with the aid of an actuator the mixing tool is insertable into the mixing chamber for mixing the media and is retractable from the mixing chamber following the mixing process.

In a refinement of the present invention of the mixing tool having mixing organs, which are inserted into the mixing chamber only for the actual mixing and are subsequently completely retractable from it, a dead volume during the mixing of the media is avoided. In this manner, an optimum mixing performance is achieved in the device according to the present invention regardless of the media used such that due to the optimum intermixture of the two media nearly the entire supplied quantity has a uniform quality with respect to the mixture.

Furthermore, by a suitable design of the mixing organs and their passageways through the wall of the mixing chamber, a minimization of waste can be achieved, which arises in known devices especially with highly viscous media such as pastes. Consequently, the device according to the present invention is suitable particularly also for the use of expensive base materials as mixing components such as e.g. platinum, palladium, rhodium, iridium and the like. For this purpose, the device according to the present invention may also take the form of a paste mixing robot.

In a suitable variant of the device according to the present invention, the mixing tool is guided into the mixing chamber through a corresponding opening in a wall bounding the mixing chamber or is pulled out of it at least so far that the mixing chamber following the mixing again has an at least nearly even inner wall.

According to a further development of the present invention it is possible for the mixing tool to have several mixing organs, which are held in the respective openings at arbitrary sections of the wall forming the mixing chamber. The arrangement of the respective mixing organs is not fixed to definite positions, but may rather be suitably adjusted possibly as a function of the media to be mixed and their states of aggregation.

For mixing the media in the mixing chamber it may be provided for at least one segment of the wall, on which the mixing organs are held in the respective openings, to be movable in the circumferential direction of the mixing chamber such that each mixing organ for mixing the media is moved along with it.

For this purpose, for example, a ring segment of the mixer housing including the respectively provided mixing organs is rotated, while the remaining mixer housing itself is torsionally fixed.

For driving the rotating segment of the mixer housing, according to a further development of the present invention, a toothing or the like may be provided, which is engaged with a drive gear. In this manner, the driving power and thus the mixing power of the device according to the present invention may be varied as required.

A further variant of the present invention may provide for the plunger to form the wall segment, having the at least one mixing organ, that is moved in the circumferential direction of the mixing chamber, the plunger having at least one corresponding opening for guiding the mixing organ through. Thus the mixing organ may be guided e.g. from above through the piston into the mixing chamber for mixing the media.

It is possible for the latter variant of the present invention to be combined with the previously mentioned variant such that mixing organs are insertable into and retractable, from the mixing chamber both through the plunger as well as also through the wall of the mixer housing. When using several mixing organs, these can be held at arbitrary sections of the plunger in the respective opening. In this manner, the mixing performance may be optimized further. For example, mixing organs may be provided along the edge region of the plunger such that media possibly adhering to the inner wall of the mixing chamber can be detached from the wall.

For driving this variant there may be a provision for the plunger to be capable of being set in rotation for mixing the media such that the media present in the mixing chamber are mixed by the mixing organs rotation along with the plunger. As a drive, for example, a drive shaft of a motor or the like may be coupled with a piston rod of the plunger.

Within the scope of an advantageous refinement of the present invention, preferably each mixing organ may take the form of a pin having a specified cross-sectional form. The respectively chosen cross-sectional form may be adapted to the properties of the media to be mixed such that an optimum intermixing is made possible. If several mixing organs are used, then different cross-sectional forms may be used for this purpose.

Preferably, for instance, square and/or rectangular and/or rhombic or other such cross-sectional forms may be provided on the mixing organs. However, other geometric forms are also conceivable.

In order to put the respective mixing organs into use following the supply of the media to be mixed it may be furthermore provided that each mixing tool has an actuator or the like assigned to it for inserting and retracting the at least one mixing organ into or from the mixing chamber. Any motor-driven device, which allows for the insertion and retraction movements of the mixing tool, may be used as an actuator.

A bayonet lock, for example, or a coupling device comparable in its effect, may be provided for the decoupling of the mixing organs from the actuator that allows for a rotation of the mixing organs along with the rotating segment of the wall of the mixing chamber. It is also conceivable that at least a part of the actuator moves along with the mixing tool in a mixing process in a linear and/or rotary manner.

The device according to the present invention is especially suitable for mixing more highly viscous media such as pastes having particularly high-quality components as are used e.g. in screen-printing methods or diverse coating methods. The device according to the present invention proves to be especially suitable for mixing pastes for thick-film technology in sensor material development as well as for catalytic coatings, e.g. of diesel particle filters.

In addition to these special fields of application, the device according to the present invention is fundamentally suitable for mixing arbitrary substances, preferably fluids however, the term “fluids” here having to be understood in its broadest sense and thus comprising gases, liquids, highly viscous fluids, suspensions, emulsions and aerogels.

### BRIEF DESCRIPTION OF THE DRAWINGS

FIG. 1 shows a schematic sectional view of a first specific embodiment of a device according to the present invention for mixing at least two media.

FIG. 2 shows a schematic sectional view of a second specific embodiment of the device according to the present invention.

FIG. 3 shows a schematic detail of the lower side of a plunger of the device according to FIG. 2.

### DETAILED DESCRIPTION

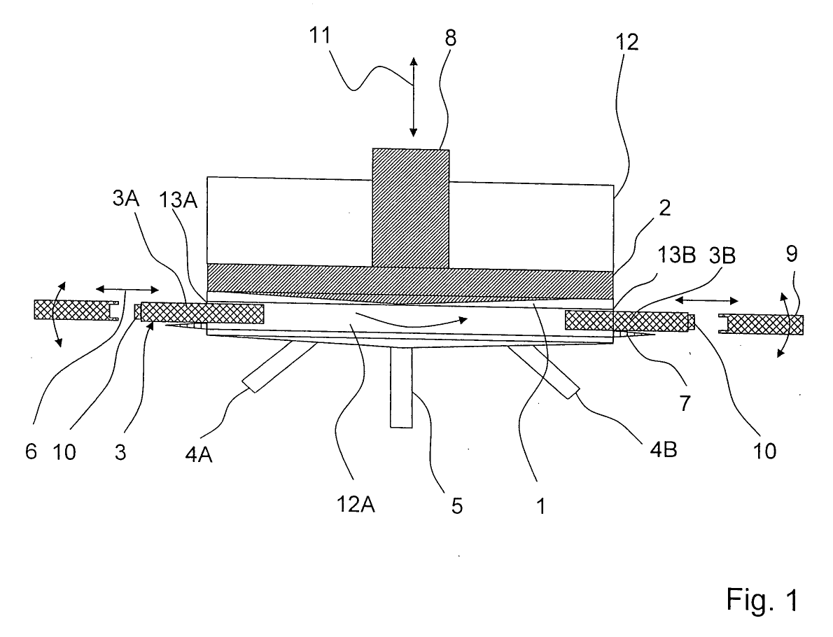

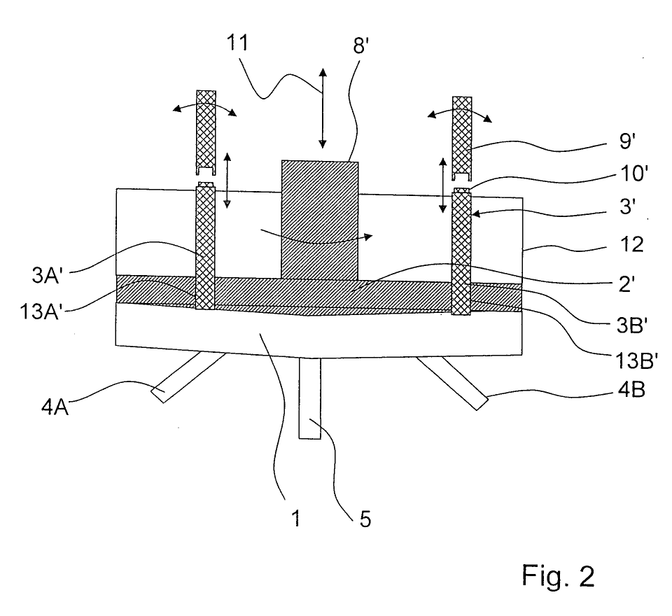

The exemplary embodiments shown in FIGS. 1 and 2 each show a device for mixing highly viscous fluids such as pastes, which is designed for integration into a system as well as for automated operation.

The device has one mixer housing 12, which essentially takes the form of a pot-like, cylindrical container.

Mixer housing 12 contains a mixing chamber 1, the volume of which is established by the inner wall of mixer housing 12 and a plunger 2 or 2′, which is designed piston-like having a piston rod 8 or 8′ and is moveable at least in a linear direction along an arrow 11 with respect to a bottom of mixer housing 12.

For charging mixing chamber 1 with the fluids to be mixed, two intake nipples 4A, 4B are formed at a bottom of mixer housing 12, the number of which may be varied in other variants according to the given requirements. Moreover, an outlet nipple 5 for removing the mixed media is located at the bottom of mixer housing 12.

In the variant according to FIG. 1, a mixing tool 3 having several mixing organs 3A, 3B for mixing the media fed into mixing chamber 1 is provided, mixing organs 3A, 3B being insertable for the mixing process into mixing chamber 1 with the aid of an actuator 9, which moves mixing organs 3A, 3B e.g. electromotorically in a linear manner along an arrow 6, and being afterwards retractable from mixing chamber 1. For this purpose, mixing organs 3A, 3B are guided or held in the wall of mixer housing 12 in an associated opening 13A or 13B corresponding to the cross-sectional form of mixing organs 3A, 3B.

The two mixing organs 3A, 3B are provided lying diametrically opposed to each other in mixing chamber 1, a ring-shaped segment 12A of the wall in the specific embodiment shown being supported in a rotating manner with respect to the remaining wall of mixing chamber 1 or mixer housing 12 such that mixing organs 3A, 3B are moved along when this segment 12A is rotated in the circumferential direction of mixing chamber 1, whereby the media contained in mixing chamber 1 are intermixed.

To drive this ring-shaped segment 12A, a toothing 7 projecting radially from segment 12A may be provided, which engages with a drive gear of a suitable driving device (not shown).

One bayonet lock 10 is respectively provided as a coupling device between actuator 9 and mixing organs 3A, 3B for a decoupling of the mixing organs 3A, 3B from actuator 9 that allows for a rotation of the mixing organs along with the rotating segment of the wall of the mixing chamber.

In the specific embodiment of a device according to the present invention shown in FIG. 2, analogous to the variant in FIG. 1, mixing organs 3A′, 3B′ of a mixing tool 3′ are guided through corresponding openings 13A′, 13B′ of plunger 2 from above into mixing chamber 1 and are also held in these openings 13A′, 13B′. To transport mixing organs 3A′, 3B′ between a resting position, in which mixing organs 3A′, 3B′ with their faces and the face of plunger 2′ facing the mixing chamber form a nearly flush surface, and a working position, in which mixing organs 3A′, 3B′ are located in mixing chamber 1, a merely schematically sketched actuator 9′ is provided, which lowers or lifts the mixing organs in a linear manner through openings 13A′, 13B′. For decoupling the rotationally movable mixing organs 3A′, 3B′ from the in this case non-rotating actuator 9′, again a bayonet lock 10′ is provided.

To activate mixing organs 3A′, 3B′, the entire piston-like plunger 2′, essentially corresponding to the variant in FIG. 1, is set in rotation such that mixing organs 3A′, 3B′ are able to mix the media contained in mixing chamber 1.

As a drive, a piston rod 8′ of plunger 2′ may be coupled with a drive shaft (not shown) of an electric motor.

In both specific embodiments, mixing organs 3A, 3B, 3A′, 3B′ are pin shaped, for example, and have specified cross-sectional forms.

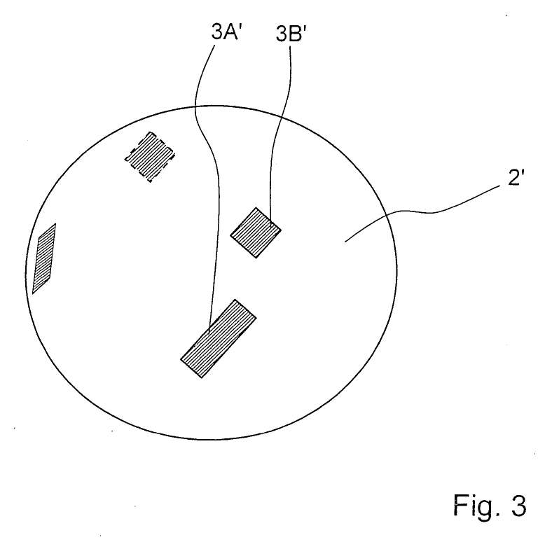

As shown in FIG. 3, square, rectangular or also rhombic cross-sectional forms may be used for example. In addition, mixing organs 3A, 3B, 3A′, 3B′ are to be arbitrarily arranged at the wall or at plunger 2, 2′.

The device according to the present invention works as follows:

At the beginning of the mixing process, plunger 2 or 2′ is moved upward to increase the size of the mixing space of mixing chamber 1 such that a negative pressure is created in mixing chamber 1, which facilitates the inflow of the media through inlet nipples 4A, 4B. As soon as the appropriate quantities of the respective media have been supplied, pin-shaped mixing organs 3A, 3B or 3A′, 3B′ are extended into mixing chamber 1 by their respective actuators 9 or 9′ such that the mixing organs, which, depending on the specific embodiment, are wing-shaped for example, are mixed either by the rotating segment of the wall of mixing chamber 1 or by rotating plunger 2′.

Following the conclusion of the mixing process, mixing organs 3A, 3B or 3A′, 3B′ are again retracted from mixing chamber 1 by their respective actuators 9 or 9′ such that plunger 2 or 2′ can then again be moved downward so as to empty mixing chamber 1 completely, the mixed media being removed through outlet nipple 5.

In the variants shown, preferably pastes for the combinatorial mixing of silk-screen printing and coating pastes are provided as media to be mixed, but other pastes or fluids may be used as well with the mixing devices shown in an optionally by one skilled in the art depending on the media to be mixed.

What is claimed is:

1. A device for mixing at least two media, comprising:
a movable plunger;
at least one mixing chamber, its volume in a mixer housing being variable by a movable plunger;
an actuator; and
at least one mixing tool, the mixing tool with the aid of the actuator being insertable into the mixing chamber for mixing the media and being retractable from the mixing chamber following the mixing.

2. The device according to claim 1, wherein the mixing tool is guidable into the mixing chamber through a corresponding opening in a wall bounding the mixing chamber.

3. The device according to claim 2, wherein the mixing tool has a plurality of mixing organs, which are held at the wall bounding the mixing chamber in respective openings.

4. The device according to claim 3, wherein at least one segment of the wall, at which mixing organs are held, is movable in a circumferential direction of the mixing chamber such that every mixing organ is moved along for mixing the media.

5. The device according to claim 4, further comprising a toothing for driving the rotating segment, the toothing being engaged with a drive gear.

6. The device according to claim 1, wherein the mixing tool has at least one mixing organ guidable into the mixing chamber through a corresponding opening of the plunger.

7. The device according to claim 6, wherein the plunger is adapted to be set in rotation for mixing the media.

8. The device according to claim 1, wherein the mixing tool has at least one mixing organ having a pin-shaped design.

9. The device according to claim 8, wherein the pin-shaped mixing organ has at least one of a substantially square, rectangular and rhombic cross-sectional form.

10. The device according to claim 3, wherein each of the at least one mixing tool is assigned one actuator for extending and retracting the mixing organs into and from the mixing chamber.

11. The device according to claim 10, wherein the actuator and at least one mixing organ are connectible via a bayonet lock.

12. The device according to claim 1, wherein the mixing tool is for mixing pastes, for one of (a) screen-printing methods and (b) coating methods.

13. The device according to claim 1, wherein the at least two media are highly viscous media.
